(19) United States
(12) Patent Application Publication
(10) Pub. No.: US 2014/0184103 A1
(43) Pub. Date: Jul. 3, 2014

(54) FEEDBACK CONTROL CIRCUIT AND POWER SUPPLY APPARATUS USING DIMMING ADJUSTMENT AND FORWARD VOLTAGE CONTROL

(71) Applicant: SAMSUNG ELECTRO-MECHANICS CO., LTD., Suwon (KR)

(72) Inventors: Min Jin Kim, Suwon (KR); Jung Woo Choi, Suwon (KR); Heung Gyoon Choi, Suwon (KR)

(73) Assignee: SAMSUNG ELECTRO-MECHANICS CO., LTD., Suwon (KR)

(21) Appl. No.: 13/793,885

(22) Filed: Mar. 11, 2013

(30) Foreign Application Priority Data
Dec. 27, 2012 (KR) 10-2012-0155302

(51) Int. Cl. H05B 33/08

(52) U.S. Cl. CPC H05B 33/0851
USPC 315/307

(57) ABSTRACT

There are provided a feedback control circuit and power supply apparatus using dimming adjustment and forward voltage control. The feedback control circuit includes: a voltage detection unit detecting an output voltage from a transformer and providing a detection voltage; a dimming unit generating a varied dimming signal; and a feedback circuit unit comparing the detection voltage with a reference voltage varied according to the dimming signal and providing a feedback voltage for controlling a power transmission ratio of the transformer.

### CROSS-REFERENCE TO RELATED APPLICATIONS

This application claims the priority of Korean Patent Application No. 10-2012-0155302 filed on Dec. 27, 2012, in the Korean Intellectual Property Office, the disclosure of which is incorporated herein by reference.

### BACKGROUND OF THE INVENTION

1. Field of the Invention

The present invention relates to a feedback control circuit and a power supply apparatus for controlling a forward voltage by using dimming adjustment and controlling a forward current based on the controlled forward voltage.

2. Description of the Related Art

In general, a power supply apparatus such as a switching mode power supply (SMPS), or the like, supplies a plurality of voltages required in electronic systems such as a cell phone, a notebook computer, a communications system, an illumination device, and the like.

Meanwhile, in an illumination device using a light emitting diode (LED), a user may need to adjust a degree of brightness of an LED according to usage environment conditions.

Thus, in an illumination device, in order to implement dimming for adjusting brightness of an LED, a method of directly controlling a driving current flowing in an LED and a method for controlling brightness of an LED by applying pulse width modulation (PWM) dimming have been adopted.

In a current control scheme used for adjusting brightness of an LED of an existing power supply apparatus, a sensing resistor is required to be used to detect a current flowing in an illuminating unit including a plurality of LEDs.

The sensing resistor commonly used for the current detection scheme generates heat corresponding to a resistance value of the sensing resistor and a current flowing in the LED. Thus, in order to lower heat generated by the sensing resistor, a high-priced sensing resistor having high power capacity may be used.

However, the sensing resistor having high power capacity is relatively expensive, increasing unit production cost of power supply apparatuses accordingly.

Patent document 1 below relates to a system and method for controlling LED illumination, but does not disclose technical matters of controlling a forward voltage by using a dimming technique and controlling a forward current thereby.

### RELATED ART DOCUMENT

(Patent document 1) Korean Patent Laid Open Publication No. 10-2008-0090763

### SUMMARY OF THE INVENTION

An aspect of the present invention provides a feedback control circuit and a power supply apparatus for controlling a forward voltage by varying a reference voltage through dimming adjustment, and controlling a forward current based on the controlled forward voltage.

According to an aspect of the present invention, there is provided a feedback control circuit including: a voltage detection unit detecting an output voltage from a transformer and providing a detection voltage; a dimming unit generating a varied dimming signal; and a feedback circuit unit comparing the detection voltage with a reference voltage varied according to the dimming signal and providing a feedback voltage for controlling a power transmission ratio of the transformer.

According to another aspect of the present invention, there is provided a power supply apparatus including: a transformer transmitting power according to a power transmission ratio between a primary winding and a secondary winding to provide an output voltage for driving an illuminating unit; a voltage detection unit detecting the output voltage from the transformer and providing a detection voltage; a dimming unit generating varied dimming signal; a feedback circuit unit comparing the detection voltage with a reference voltage varied according to the dimming signal and providing a feedback voltage; a signal transmission unit transmitting the feedback voltage; and a pulse width modulation (PWM) controller controlling the power transmission ratio between the primary winding and the secondary winding of the transformer based on the feedback voltage transmitted from the signal transmission unit.

The voltage detection unit may include a first detection resistor having one end connected to an output node connected to an output terminal of the transformer and the other end; and a second detection resistor having one end connected to the other end of the first detection resistor and the other end connected to a ground, wherein the detection voltage is provided from a detection connection node between the first detection resistor and the second detection resistor.

The dimming unit may include a variable resistor providing a resistance value varied by the dimming signal.

The feedback circuit unit may include: a reference voltage generation unit dividing an operating voltage according to a voltage dividing ratio adjusted according to a resistance value from the variable resistor of the dimming unit; and a comparison unit providing the feedback voltage corresponding to a difference between the detection voltage and the reference voltage.

The reference voltage generation unit may include: a first dividing resistor having one end connected to an input terminal of the operating voltage and the other end; and a second dividing resistor having one end connected to the other end of the first dividing resistor and the other end connected to a ground, wherein the reference voltage is provided from a division connection node between the first dividing resistor and the second dividing resistor and the second dividing resistor is connected to the variable resistor of the dimming unit in parallel, according to which the voltage dividing ratio in the division connection node is varied.

The dimming unit may include a pulse generation unit providing a pulse signal having a low level and a high level, as a dimming signal.

The feedback circuit unit may include: a reference voltage generation unit dividing a pre-set operating voltage to generate a reference voltage, the reference voltage being varied according to the pulse signal; and a comparison unit providing the feedback voltage corresponding to a difference between the detection voltage and the reference voltage.

The reference voltage generation unit may include: a first dividing resistor having one end connected to an input terminal of the operating voltage and the other end; and a second dividing resistor having one end connected to the other end of the first dividing resistor and the other end connected to a ground, wherein the reference voltage is provided from a division connection node between the first dividing resistor and the second dividing resistor, and an output terminal of the dimming unit is connected to the division connection node, so the reference voltage is varied according to the pulse signal.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a circuit block diagram of a feedback control circuit and a power supply apparatus according to an embodiment of the present invention;

FIG. 2 is a view illustrating an example of a voltage detection unit according to an embodiment of the present invention;

FIG. 3 is a view illustrating a first example of a dimming unit and a feedback circuit unit according to an embodiment of the present invention;

FIG. 4 is a view illustrating a second example of a dimming unit and a feedback circuit unit according to an embodiment of the present invention; and

FIG. 5 is graph showing a relationship between an output voltage and an output current of an illuminating unit according to an embodiment of the present invention.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art. In the drawings, the shapes and dimensions of elements may be exaggerated for clarity, and the same reference numerals will be used throughout to designate the same or like components.

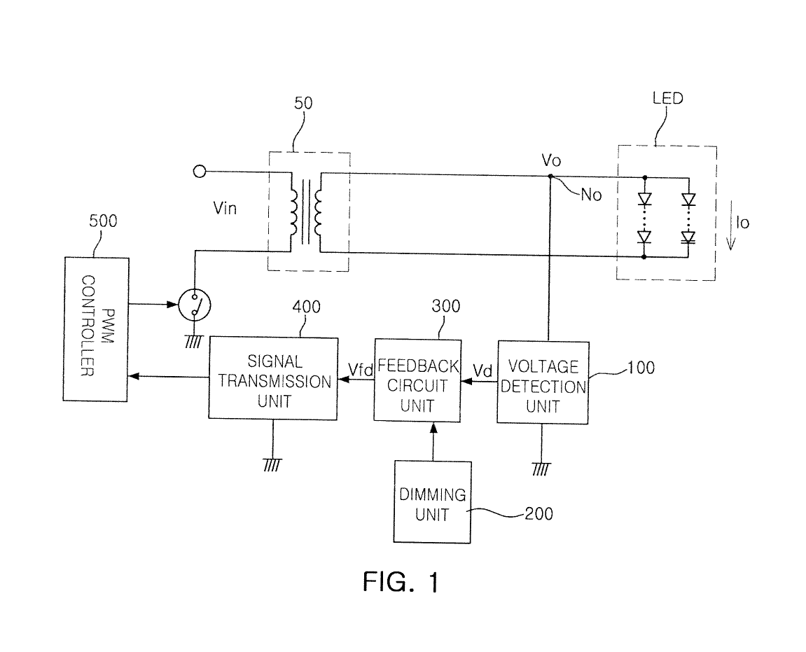

FIG. 1 is a circuit block diagram of a feedback control circuit and a power supply apparatus according to an embodiment of the present invention.

Referring to FIG. 1, a feedback control circuit according to an embodiment of the present invention may include a voltage detection unit 100, a dimming unit 200, and a feedback circuit unit 300.

A power supply apparatus according to an embodiment of the present invention may include a transformer 50, the voltage detection unit 100, the dimming unit 200, the feedback circuit unit 300, a signal transmission unit 400, and a pulse width modulation (PWM) controller 500.

The transformer 50 may transmit power according to a power transmission ratio between a primary winding and a secondary winding, to provide an output voltage Vo for driving an illuminating unit LED.

Namely, a power switch is connected to the primary winding, and here, the power switch is controlled by a PWM signal. In this case, a power transmission ratio between the primary winding and the secondary winding may be controlled by varying a width of the PWM signal.

Meanwhile, the transformer 50 may further include a filter or a rectifying circuit for stabilizing the output voltage Vo.

The voltage detection unit 100 may detect the output voltage Vo from the transformer 50 to provide a detection voltage Vd. For example, the voltage detection unit 100 may include a plurality of resistors for dividing the output voltage Vo.

The dimming unit 200 may generate a variable dimming signal. For example, the dimming unit 200 may be implemented as a dimmer such as a variable resistor, or may be implemented as a PWM generation unit generating a PWM signal. The dimming unit 200 may not be limited thereto.

The feedback circuit unit 300 may compare the detection voltage Vd with a reference voltage Vref varied according to the dimming signal and provide a feedback voltage Vfd for controlling a power transmission ratio of the transformer.

The signal transmission unit 400 may transmit the feedback voltage Vfd. The signal transmission unit 400 may be configured as a photocoupler for transmitting the feedback voltage Vfd in an optical coupling manner.

In this case, the photocoupler may include a light emitting unit generating light corresponding to a magnitude of the feedback voltage Vfd and a light receiving unit receiving light from the light emitting unit and providing it as a feedback voltage.

The PWM controller 500 may control a power transmission ratio of the transformer 50 based on the feedback voltage transferred from the signal transmission unit 400.

For example, the PWM controller 500 may generate a PWM signal having a pulse width varied according to a magnitude of the feedback voltage, and control the power switch connected to the primary winding of the transformer 50 with the PWM signal.

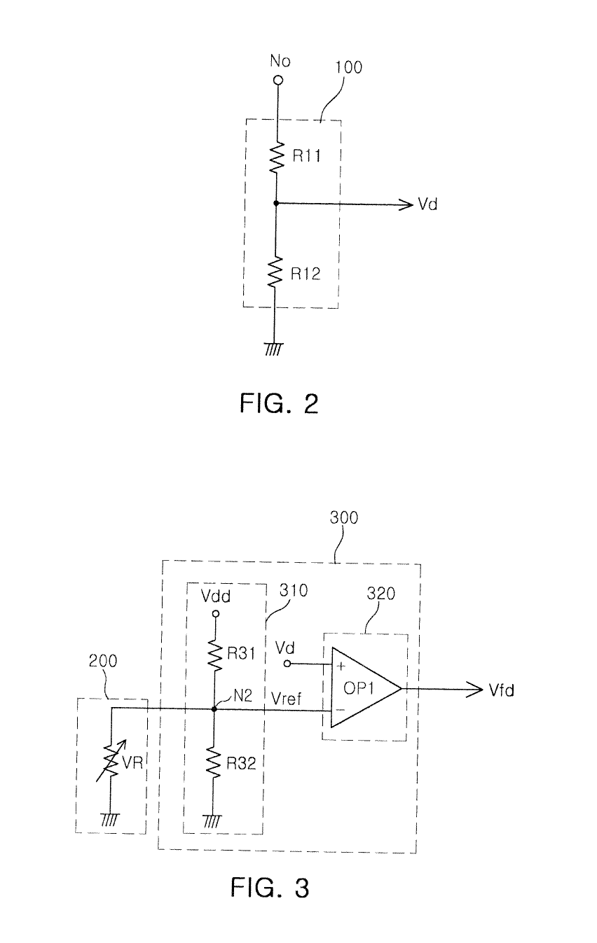

FIG. 2 is a view illustrating an example of a voltage detection unit according to an embodiment of the present invention.

Referring to FIG. 2, the voltage detection unit 100 may include a first detection resistor R11 having one end connected to an output node No connected to an output terminal of the transformer 50 and the other end, and a second detection resistor R12 having one end connected to the other end of the first detection resistor R11 and the other end connected to a ground.

Here, the detection voltage Vd may be provided from a detection connection node N1 between the first detection resistor R11 and the second detection resistor R12.

Here, a current flowing in the voltage detection unit 100 is significantly low, relative to a current flowing in the illuminating unit LED, and thus, heat generated by the current and the first detection resistor R11 and the second detection resistor R12 is considerably low.

For example, when the output voltage is 24V, overall resistance of the voltage detection unit 100 is increased to be considerably high relative to overall resistance of the illuminating unit LED, so that a high current (e.g., 1 A) flows in the illuminating unit LED and a low current (e.g., 0.01 A) flows in the voltage detection unit 100. Thus, heat generated by the first detection resistance R1 and the second detection resistance R12 of the voltage detection unit 100 is significantly low.

FIG. 3 is a view illustrating a first example of the dimming unit and the feedback circuit unit according to an embodiment of the present invention.

Referring to FIG. 3, the dimming unit 200 may include a variable resistor VR providing a resistance value varied as the dimming signal.

Also, the feedback circuit unit 300 may include a reference voltage generation unit 310 and a comparison unit 320.

The reference voltage generation unit 310 may divide an operating voltage Vdd according to a voltage dividing ratio regulated according to the resistance value from the variable resistor VR of the dimming unit 200 to generate the reference voltage Vref.

For example, the reference voltage generation unit 310 may include a first dividing resistor R31 having one end connected to an input terminal of the operating voltage Vdd and the other end, and a second dividing resistor R32 having one end connected to the other end of the first dividing resistor R31 and the other end connected to a ground.

The reference voltage Vref may be provided from a division connection node N2 between the first dividing resistor R31 and the second dividing resistor R32, and the second dividing resistor R32 may be connected to the variable resistor VR of the dimming unit 200 in parallel to vary the voltage dividing ratio from the division connection node N2.

In this manner, when the voltage dividing ratio is varied, the reference voltage Vref provided from the division connection node N2 may be varied. When the reference voltage Vref is varied, a feedback voltage provided from the comparison unit 320 may be varied.

Referring to FIG. 3, the comparison unit 320 may provide the feedback voltage Vfd corresponding to a difference between the detection voltage Vd and the reference voltage Vref.

In an implementation example, the comparison unit 320 may include an operational amplifier OP1 having a non-inverting input terminal receiving the detection voltage Vd, an inverting input terminal receiving the reference voltage Vref, and an output terminal providing the feedback voltage Vfd.

In this case, when the detection voltage Vd is 2.5V and the reference voltage Vref is changed from 2.0V to 2.2V, the feedback voltage Vfd corresponding to the difference therebetween may be changed from 0.5V to 0.3V.

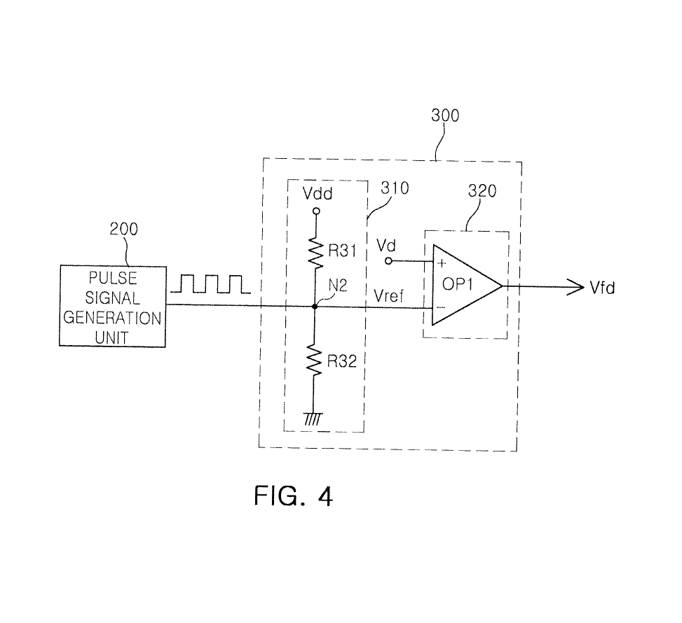

FIG. 4 is a view illustrating a second example of the dimming unit and the feedback circuit unit according to an embodiment of the present invention.

Referring to FIG. 4, the dimming unit 200 may include a pulse signal generation unit, and the pulse signal generation unit may provide a pulse signal having a low level and a high level, as a dimming signal, to the feedback circuit unit 300.

Also, the feedback circuit unit 300 may include the reference voltage generation unit 310 and the comparison unit 320.

The reference voltage generation unit 310 may divide the pre-set operating voltage Vdd to generate the reference voltage Vref, and the reference voltage Vref may be varied according to the pulse signal.

For example, the reference voltage generation unit 310 may include the first dividing resistor R31 having one end connected to an input terminal of the operating voltage Vdd and the other end, and the second dividing resistor R32 having one end connected to the other end of the first dividing resistor R31 and the other end connected to a ground.

The reference voltage Vref may be provided from the division connection node N2 between the first dividing resistor R31 and the second dividing resistor R32, and an output terminal of the dimming unit 200 may be connected to the division connection node 2, so the reference voltage Vref may be varied according to the pulse signal.

For example, when the pulse signal has a low level, a potential in the division connection node N2 has a low level, and when the pulse signal has a high level, a potential in the division connection node N2 is the reference voltage Vref. In this manner, the reference voltage Vref provided from the division connection node N2 may be varied according to the pulse signal.

Referring to FIG. 4, the comparison unit 320 may compare the detection voltage Vd with the reference voltage Vref and provide the feedback voltage Vfd corresponding to a difference between the detection voltage Vd and the reference voltage Vref.

In an implementation example, the comparison unit 320 may include the operational amplifier OP1 having a non-inverting input terminal receiving the detection voltage Vd, an inverting input terminal receiving the reference voltage Vref, and an output terminal providing the feedback voltage Vfd.

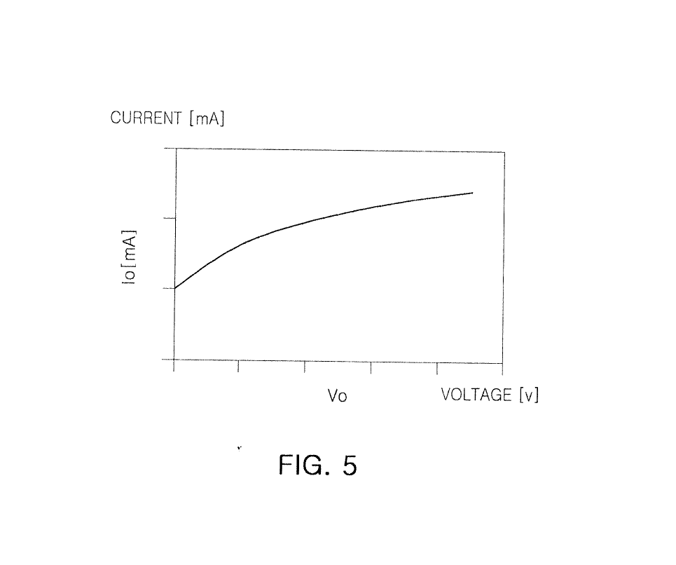

FIG. 5 is graph showing a relationship between an output voltage and an output current of an illuminating unit according to an embodiment of the present invention.

Referring to the graph showing the relationship between the output voltage Vo and the output current Io of the illuminating unit LED according to an embodiment of the present invention illustrated in FIG. 5, the output voltage Vo and the output current Io in the illuminating unit LED has a linear proportional relationship. This means that the output current Io of the illuminating unit LED can be controlled by controlling the output voltage Vo of the illuminating unit LED.

In the embodiment of the present invention as described above, the V-I relationship characteristics of the illuminating unit such as an LED chip, or the like, are used. Namely, a forward current is varied by controlling a forward voltage applied to the illuminating unit LED.

Also, the forward voltage may be controlled by varying a reference voltage for controlling the forward voltage according to a dimming method.

As set forth above, according to embodiments of the invention, a forward voltage is controlled by varying the reference voltage through dimming adjustment, a forward current is controlled according to the controlled forward voltage.

While the present invention has been shown and described in connection with the embodiments, it will be apparent to those skilled in the art that modifications and variations can be made without departing from the spirit and scope of the invention as defined by the appended claims.

What is claimed is:

1. A feedback control circuit comprising:
a voltage detection unit detecting an output voltage from a transformer and providing a detection voltage;
a dimming unit generating a varied dimming signal; and
a feedback circuit unit comparing the detection voltage with a reference voltage varied according to the dimming signal and providing a feedback voltage for controlling a power transmission ratio of the transformer.

2. The feedback control circuit of claim 1, wherein the voltage detection unit comprises:
a first detection resistor having one end connected to an output node connected to an output terminal of the transformer and the other end; and
a second detection resistor having one end connected to the other end of the first detection resistor and the other end connected to a ground,
wherein the detection voltage is provided from a detection connection node between the first detection resistor and the second detection resistor.

3. The feedback control circuit of claim 1, wherein the dimming unit includes a variable resistor providing a resistance value varied by the dimming signal.

4. The feedback control circuit of claim 3, wherein the feedback circuit unit comprises:
a reference voltage generation unit dividing an operating voltage according to a voltage dividing ratio adjusted according to a resistance value from the variable resistor of the dimming unit; and
a comparison unit providing the feedback voltage corresponding to a difference between the detection voltage and the reference voltage.

5. The feedback control circuit of claim 4, wherein the reference voltage generation unit comprises:
a first dividing resistor having one end connected to an input terminal of the operating voltage and the other end; and
a second dividing resistor having one end connected to the other end of the first dividing resistor and the other end connected to a ground,
wherein the reference voltage is provided from a division connection node between the first dividing resistor and the second dividing resistor and the second dividing resistor is connected to the variable resistor of the dimming unit in parallel, according to which the voltage dividing ratio in the division connection node is varied.

6. The feedback control circuit of claim 1, wherein the dimming unit comprises a pulse generation unit providing a pulse signal having a low level and a high level, as a dimming signal.

7. The feedback control circuit of claim 3, wherein the feedback circuit unit comprises:
a reference voltage generation unit dividing a pre-set operating voltage to generate a reference voltage, the reference voltage being varied according to the pulse signal; and
a comparison unit providing the feedback voltage corresponding to a difference between the detection voltage and the reference voltage.

8. The feedback control circuit of claim 7, wherein the reference voltage generation unit comprises:
a first dividing resistor having one end connected to an input terminal of the operating voltage and the other end; and
a second dividing resistor having one end connected to the other end of the first dividing resistor and the other end connected to a ground,
wherein the reference voltage is provided from a division connection node between the first dividing resistor and the second dividing resistor, and an output terminal of the dimming unit is connected to the division connection node, so the reference voltage is varied according to the pulse signal.

9. A power supply apparatus comprising:
a transformer transmitting power according to a power transmission ratio between a primary winding and a secondary winding to provide an output voltage for driving an illuminating unit;
a voltage detection unit detecting the output voltage from the transformer and providing a detection voltage;
a dimming unit generating varied dimming signal;
a feedback circuit unit comparing the detection voltage with a reference voltage varied according to the dimming signal and providing a feedback voltage;
a signal transmission unit transmitting the feedback voltage; and
a pulse width modulation (PWM) controller controlling the power transmission ratio between the primary winding and the secondary winding of the transformer based on the feedback voltage transmitted from the signal transmission unit.

10. The power supply apparatus of claim 9, wherein the voltage detection unit comprises:
a first detection resistor having one end connected to an output node connected to an output terminal of the transformer and the other end; and
a second detection resistor having one end connected to the other end of the first detection resistor and the other end connected to a ground,
wherein the detection voltage is provided from a detection connection node between the first detection resistor and the second detection resistor.

11. The power supply apparatus of claim 9, wherein the dimming unit includes a variable resistor providing a resistance value varied by the dimming signal.

12. The power supply apparatus of claim 11, wherein the feedback circuit unit comprises:
a reference voltage generation unit dividing an operating voltage according to a voltage dividing ratio adjusted according to a resistance value from the variable resistor of the dimming unit; and
a comparison unit providing the feedback voltage corresponding to a difference between the detection voltage and the reference voltage.

13. The power supply apparatus of claim 12, wherein the reference voltage generation unit comprises:
a first dividing resistor having one end connected to an input terminal of the operating voltage and the other end; and
a second dividing resistor having one end connected to the other end of the first dividing resistor and the other end connected to a ground,
wherein the reference voltage is provided from a division connection node between the first dividing resistor and the second dividing resistor and the second dividing resistor is connected to the variable resistor of the dimming unit in parallel, according to which the voltage dividing ratio in the division connection node is varied.

14. The power supply apparatus of claim 9, wherein the dimming unit includes a pulse generation unit providing a pulse signal having a low level and a high level, as a dimming signal.

15. The power supply apparatus of claim 11, wherein the feedback circuit unit comprises:
a reference voltage generation unit dividing a pre-set operating voltage to generate a reference voltage, the reference voltage being varied according to the pulse signal; and
a comparison unit providing the feedback voltage corresponding to a difference between the detection voltage and the reference voltage.

16. The power supply apparatus of claim 15, wherein the reference voltage generation unit comprises:
a first dividing resistor having one end connected to an input terminal of the operating voltage and the other end; and
a second dividing resistor having one end connected to the other end of the first dividing resistor and the other end connected to a ground,
wherein the reference voltage is provided from a division connection node between the first dividing resistor and the second dividing resistor, and an output terminal of the dimming unit is connected to the division connection node, so the reference voltage is varied according to the pulse signal.
